(19) United States
(12) Patent Application Publication
(10) Pub. No.: US 2018/0293872 A1
(43) Pub. Date: Oct. 11, 2018

(54) Method and Apparatus for Reminding Forgotten Mobile Terminal

(71) Applicant: BOE TECHNOLOGY GROUP CO., LTD., Beijing (CN)

(72) Inventors: Zhenpeng GUO, Beijing (CN); Zhiqiang QIANG, Beijing (CN); Junjie ZHAO, Beijing (CN)

(21) Appl. No.: 15/868,189

(22) Filed: Jan. 11, 2018

(30) Foreign Application Priority Data
Apr. 10, 2017 (CN) 201710228164.3

(51) Int. Cl. G08B 21/24; H04M 1/725

(52) U.S. Cl. CPC G08B 21/24; H04M 1/72527

(57) ABSTRACT

The present disclosure provides a method and an apparatus for reminding a forgotten mobile terminal, wherein information of a mobile terminal currently connected to a predetermined device is detected, detected information of the mobile terminal connected to the predetermined device is compared with preset information so as to judge whether both of them are the same with each other, in a case where both of them are different from each other, it indicates that there is a mobile terminal that should be taken way, and in this case, a user is notified and reminded to take away the mobile terminal in time, avoiding unnecessary troubles for people's life and work due to forgetting the mobile terminal.

### CROSS REFERENCE FOR RELATED APPLICATION

The present disclosure requires the priority of Chinese patent application No.201710228164.3 filed on April 10, 2017, the full content of which is incorporated here by reference.

### FIELD

The present disclosure relates to the field of communication technology, and particularly to a method and an apparatus for reminding a forgotten mobile terminal.

### BACKGROUND

With the progress of science and technology and the improvement of people's life, portable mobile terminals such as mobile phone, smart band, tablet computer etc. have become people's essential belongings, however, people often unconsciously leave their portable mobile terminals in a place, which brings unnecessary troubles to life and work, for example, more and more people have a vehicle now, when people ride or drive the vehicle, their portable mobile terminals are placed in the vehicle, and when people leave the vehicle, their portable mobile terminals such as mobile phone, smart band, tablet computer etc. are often forgotten in the vehicle.

### SUMMARY

The present disclosure provides a method for reminding a forgotten mobile terminal, includes steps: S1, detecting information of a mobile terminal connected to a predetermined device; S2, comparing detected information of the mobile terminal connected to the predetermined device with preset information to judge whether both of them are the same with each other; S3, notifying a user whether there is a mobile terminal that should be taken away in accordance with a judgment result of S2.

In some implementations, the information of the mobile terminal to be detected includes the number of mobile terminals, and the preset information includes a preset threshold, in a case where a detected number of the mobile terminals connected to the predetermined device is different from the preset threshold, the step S2 further includes calculating a difference between the number of the mobile terminals connected to the predetermined device and the preset threshold, and the step S3 further includes notifying the user of the difference.

In some implementations, the step S3 includes: transmitting the difference to a predetermined terminal.

In some implementations, the information of the mobile terminal to be detected includes an identifier of the mobile terminal, and the preset information includes a preset identifier of a mobile terminal, in a case where the detected identifier of the mobile terminal connected to the predetermined device is different from the preset identifier, the step S2 further includes determining the identifier of the mobile terminal different from the preset identifier, and the step S3 further includes notifying the user of the determined identifier of the mobile terminal different from the preset identifier.

In some implementations, the information of the mobile terminal to be detected includes the number of mobile terminals and identifiers of the mobile terminals, the preset information includes a preset threshold and a preset identifier of a mobile terminal, and in a case where the detected number of the mobile terminals connected to the predetermined device is different from the preset threshold and the detected identifiers of the mobile terminals are not all the same as the preset identifier, the step S2 further includes calculating a difference between the number of the mobile terminals connected to the predetermined device and the preset threshold and determining an identifier of a mobile terminal among the mobile terminals different from the preset identifier, and the step S3 further includes notifying the user of the calculated difference and the determined identifier of the mobile terminal different from the preset identifier.

In some implementations, the method of the present disclosure may further include steps of detecting the number of mobile terminals connected to the predetermined device periodically by taking a predetermined first time period as a cycle; determining a minimal value of the number of the mobile terminals connected to the predetermined device by taking a predetermined second time period as a cycle, and setting the minimal value as the preset threshold, the predetermined second time period includes at least one the predetermined first time period.

In some implementations, the predetermined device is a device fixed in a place where the user is leaving, and a trigger condition which triggers the step S1 to be executed is an event which indicates that the user is leaving the place.

In some implementations, the step S1 includes detecting the information of mobile terminals connected to the predetermined device in respective ways, and calculating the total number of the mobile terminals connected to the predetermined devices in respective ways.

In some implementations, the step S1 includes: detecting identifiers of all mobile terminals connected to the predetermined device in respective ways.

The present disclosure further provides an apparatus for reminding a forgotten mobile terminal, including a processor configured to detect information of a mobile terminal connected to a predetermined device, compare the detected information of the mobile terminal connected to the predetermined device with preset information to judge whether both of them are the same with each other, and notify a user whether there is a mobile terminal should be taken away in accordance with a judgment result.

In some implementations, the information of the mobile terminal to be detected includes the number of mobile terminals, and the preset information includes a preset threshold, the processor is configured to, in a case where the detected number of the mobile terminals connected to the predetermined device is different from the preset threshold, calculate a difference between the number of the mobile terminals connected to the predetermined device and the preset threshold, and notify the user of the difference.

In some implementations, the processor is configured to transmit the difference to a predetermined terminal.

In some implementations, the information of the mobile terminal to be detected includes an identifier of the mobile terminal, and the preset information includes a preset identifier of a mobile terminal, the processor is configured to, in a case where the detected identifier of the mobile terminal connected to the predetermined device is different from the preset identifier, determine the identifier of the mobile terminal different from the preset identifier, and notify the user of the determined identifier of the mobile terminal different from the preset identifier.

In some implementations, the information of the mobile terminal to be detected includes the number of mobile terminals and identifiers of the mobile terminals, the preset information includes a preset threshold and a preset identifier, and the processor is configured to, in a case where the detected number of the mobile terminals connected to the predetermined device is different from the preset threshold and the detected identifiers of the mobile terminals are not all the same as the preset identifier, calculate a difference between the number of the mobile terminals connected to the predetermined device and the preset threshold and determining an identifier of a mobile terminal among the mobile terminals different from the preset identifier, and notify the user of the calculated difference and the determined identifier of the mobile terminal different from the preset identifier.

In some implementations, the processor may further be configured to detect the number of mobile terminals connected to the predetermined device periodically by taking a predetermined first time period as a cycle, determine a minimal value of the number of the mobile terminals connected to the predetermined device by taking a predetermined second time period as a cycle, and setting the minimal value as the preset threshold, wherein the predetermined second time period includes at least one the predetermined first time period.

In some implementations, the predetermined device is a device fixed in a place where the user is leaving, and a trigger condition which triggers the processor to start to detect the information of the mobile terminal connected to the predetermined device is an event which indicates that the user is leaving the place.

In some implementations, the processor is configured to detect the information of mobile terminals connected to the predetermined device in respective ways, and calculate a total number of the mobile terminals connected to the predetermined devices in respective ways.

In some implementations, the processor is configured to detect identifiers of all mobile terminals connected to the predetermined device in respective ways.

The present disclosure further provides a recording medium recorded with a computer program for executing the method of the present disclosure for reminding the forgotten mobile terminal.

### BRIEF DESCRIPTION OF THE DRAWINGS

FIG. 1 shows a flowchart of a method for reminding a forgotten mobile terminal in the present disclosure;

FIG. 2 shows a flowchart of a method for reminding a forgotten mobile terminal in accordance with a first embodiment of the present disclosure;

FIG. 3 shows a flowchart of a method for reminding a forgotten mobile terminal in accordance with a second embodiment of the present disclosure;

FIG. 4 shows a flowchart of a method for updating a preset threshold automatically in accordance with the second embodiment of the present disclosure;

FIG. 5 shows a flowchart of a method for reminding a forgotten mobile terminal in accordance with a third embodiment of the present disclosure;

FIG. 6 shows a flowchart of a method for reminding a forgotten mobile terminal in accordance with a fourth embodiment of the present disclosure;

FIG. 7 shows a structural diagram of an apparatus for reminding a forgotten mobile terminal in an embodiment of the present disclosure.

### DETAILED DESCRIPTION OF THE EMBODIMENTS

Technical solutions of the present disclosure will be described clearly below in conjunction with drawings, and obviously, embodiments described are a portion of embodiments, but not all embodiments. All other embodiments obtained by persons skilled in the art based on the embodiments of the present disclosure without any creative work fall into the protection scope of the present disclosure.

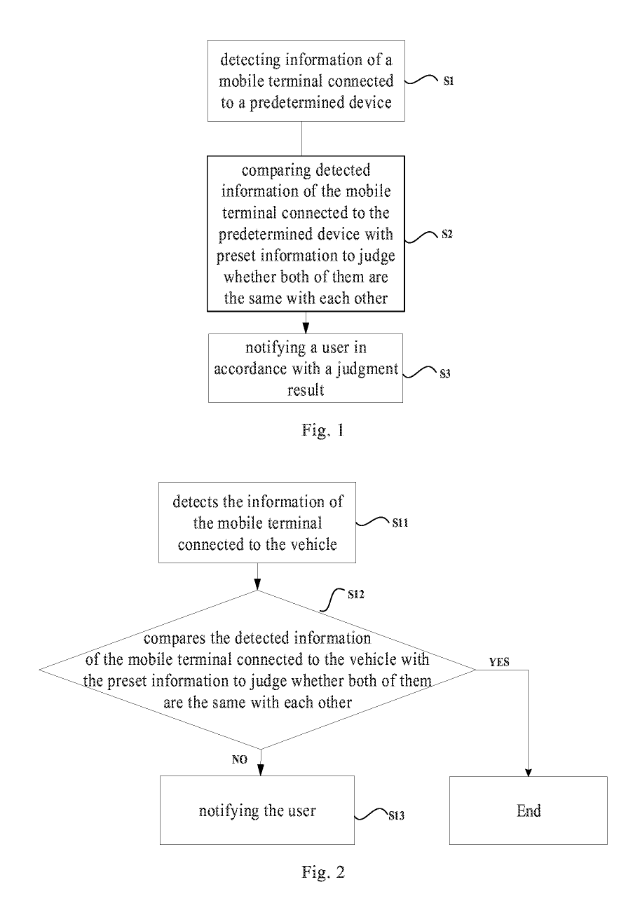

As shown in FIG. 1, the present disclosure provides a method for reminding a forgotten mobile terminal, including steps: S1, detecting information of a mobile terminal connected to a predetermined device; S2, comparing detected information of the mobile terminal connected to the predetermined device with preset information to judge whether both of them are the same with each other; S3, notifying a user whether there is a mobile terminal should be taken away in accordance with a judgment result of S2.

The technical solution of the present disclosure may be applied to a scene where a user carries a mobile terminal to get in a vehicle to ride or drive the vehicle with the mobile terminal being placed in the vehicle and then leaves the vehicle, in this scene, when the mobile terminal is in the vehicle, it connects with the vehicle, and when the mobile terminal is out of the vehicle, it disconnects with the vehicle, embodiments of the present disclosure are illustrated by taking the scene said above as an example.

For example, the mobile terminal can connect with the vehicle via any of communicable connections such as Bluetooth, Infrared, Wi-Fi and so on, and a vehicle controller can detect the information of the mobile terminal connected to the vehicle.

### First Embodiment

A procedure of a method for reminding a forgotten mobile terminal in accordance with the present embodiment is described in detail below in conjunction with FIG. 2.

As shown in FIG. 2, the method for reminding a forgotten mobile terminal in accordance with the present embodiment includes following steps S11 through S13.

S11, the vehicle controller detects the information of the mobile terminal connected to the vehicle.

For example, the vehicle controller is triggered by latch of the vehicle to detect the information of the mobile terminal connected to the vehicle, after the latch of the vehicle, the vehicle controller detects the information of the mobile terminal currently connected to the vehicle, the information of the mobile terminal to be detected may include the number of mobile terminals and/or identifiers of the mobile terminals.

S12, the vehicle controller compares the detected information of the mobile terminal connected to the vehicle with the preset information to judge whether both of them are the same with each other.

Specifically, for example, the vehicle controller may judge whether the information of the mobile terminal connected to the vehicle and the preset information are the same with each other, in a case where they are the same with each other, it indicates that there is no mobile terminal forgotten in the vehicle, the procedure is finished, and in a case where they are different from each other, it indicates that there is a mobile terminal forgotten in the vehicle, the following step S13 should be executed.

S13, the vehicle controller notifies the user whether there is a mobile terminal forgotten in the vehicle in accordance with the judgment result of S12.

Specifically, the vehicle controller may notify the user of information indicating the difference between the information of the mobile terminal connected to the vehicle and the preset information.

With steps S11 through S13, in the solution of the present embodiment for reminding the forgotten mobile terminal, when a trigger condition is satisfied, the vehicle controller is triggered to detect the information of the mobile terminal currently connected to the vehicle, then whether the information of the mobile terminal currently connected to the vehicle and the preset information are the same with each other is judged, in a case where they are different from each other, it indicates that there is a mobile terminal forgotten in the vehicle by the user, and in this case, the user is notified and reminded to take away the forgotten mobile terminal in time, avoiding unnecessary troubles for people's life and work due to the mobile terminal being forgotten in the vehicle.

It should be noted that, the trigger condition for triggering the vehicle controller to detect the information of the mobile terminal connected to the vehicle may be adjusted and set in accordance with a practical application scene. The trigger condition may be an event that an engine of the vehicle is shut down or the vehicle arrives at a destination, in this case, the user can be remind in time to avoid the mobile terminal being forgotten in the vehicle when the user leaves the vehicle. In a case where the trigger condition is the vehicle being arriving at the destination, the vehicle controller can receive the information indicating the vehicle being arriving at the destination from a navigator as the trigger condition. Furthermore, the destination may be a preset location, for example, a company's parking space, a public parking lot, or a residential garage etc. may be set as the destination in advance, and for example, whether the vehicle arrives at the preset destination may be judged in accordance with positioning information, and when the positioning information indicates that the vehicle arrives at the preset destination, the vehicle controller is triggered to detect the information of the mobile terminal connected to the vehicle.

Moreover, in a case where the step S11 is triggered to be executed before the user leaves the vehicle and it is known that the user has carried a mobile terminal into the vehicle, the step S12 may be omitted, and in the step S13, the vehicle controller reminds the user to take away the mobile terminal.

### Second Embodiment

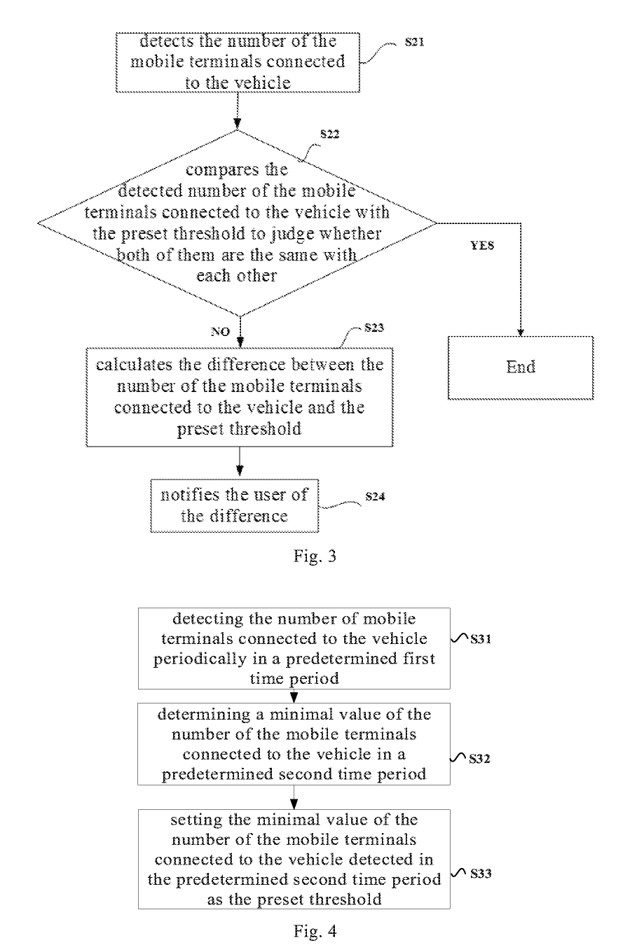

A procedure of a method for reminding a forgotten mobile terminal in accordance with the present embodiment is described in detail below in conjunction with FIG. 3.

In the present embodiment, the information of the mobile terminal detected by the vehicle controller is the number of mobile terminals, and the preset information includes a preset threshold.

As shown in FIG. 3, the method for reminding the forgotten mobile terminal in the present embodiment includes following steps S21 through S24.

S21, the vehicle controller detects the number of the mobile terminals connected to the vehicle.

It should be noted that, for example, different mobile terminals may be connected to the vehicle in different ways, and correspondingly, the vehicle controller may detect the numbers of the mobile terminals connected to the vehicle in respective ways, and calculate the total number of the mobile terminal connected to the vehicle in respective ways. Specifically, by taking different mobile terminals being respectively connected to the vehicle via Bluetooth, Infrared, and Wi-Fi as example, the vehicle controller detects that the number of the mobile terminals connected to the vehicle via Bluetooth is N1, the number of the mobile terminals connected to the vehicle via Infrared is N2 and the number of the mobile terminals connected to the vehicle via Wi-Fi is N3, the vehicle controller calculates the sum of N1, N2 and N3 to obtain the total number N4 of the mobile terminals connected to the vehicle.

S22, the vehicle controller compares the detected number of the mobile terminals connected to the vehicle with the preset threshold to judge whether both of them are the same with each other.

For example, the preset threshold may be the number of the mobile terminals that are always placed in the vehicle and do not have to be taken away from the vehicle. Specifically, the vehicle controller may judge whether the number of the mobile terminals currently connected to the vehicle and the preset threshold are the same with each other, in a case where they are the same with each other, it indicates that there is no mobile terminal forgotten in the vehicle, the procedure is finished, and in a case where they are different from each other (e.g., the number of the mobile terminals currently connected to the vehicle is greater than the preset threshold), it indicates that there is a mobile terminal forgotten in the vehicle, the following step S23 should be executed.

It should be noted that, the preset threshold may be set manually or updated automatically, the procedure of updating the preset threshold automatically will be described in detail later.

S23, the vehicle controller calculates the difference between the number of the mobile terminals connected to the vehicle and the preset threshold.

Specifically, in a case where the number of the mobile terminals currently connected to the vehicle and the preset threshold are different from each other, the vehicle controller calculates the difference between the number of the mobile terminals currently connected to the vehicle and the preset threshold, the difference indicates the number of the mobile terminals that should be taken away from the vehicle but are forgotten in the vehicle.

S24, the vehicle controller notifies the user of the calculated difference between the number of the mobile terminals currently connected to the vehicle and the preset threshold.

For example, the vehicle controller may transmit the calculated difference between the number of the mobile terminals connected to the vehicle and the preset threshold to another device so as to notify the user by it. As an example, lights of the vehicle may flicker corresponding times, an alarm of the vehicle may sound corresponding times, or a navigator may broadcast in voice to notify the user of the number of the mobile terminals forgotten in the vehicle, in accordance with the calculated difference between the number of the mobile terminals connected to the vehicle and the preset threshold. Moreover, the vehicle controller may also transmit the calculated difference between the number of the mobile terminals connected to the vehicle and the preset threshold to a preset mobile terminal that the user always carries, which will not be affected by environment, time and distance, thus has a better effect.

For example, the preset mobile terminal that the user always carries may be a mobile phone of the user, and in this case, the number of the mobile terminals forgotten in the vehicle may be notified to the user by a short message. Certainly, the preset mobile terminal that the user always carries may also be a wearable device such as a smart watch, a smart band or the like, and in this case, the number of the mobile terminals forgotten in the vehicle may be notified to the user by vibrating the corresponding wearable device corresponding times or flickering a light of the corresponding wearable device corresponding times.

With steps S21 through S24, the solution of the present embodiment for reminding the forgotten mobile terminal can notify the user of the number of the mobile terminals forgotten in the vehicle so as to ensure that the user can take away all the mobile terminals forgotten in the vehicle.

It should be noted that, in a case where the step S21 is triggered to be executed before the user leaves the vehicle and it is known that the user has carried a mobile terminal into the vehicle, the step S22 may be omitted, and in the step S23, the difference between the number of the mobile terminals connected to the vehicle and the preset threshold is calculated, and in the step S24, the user is reminded of the number of the mobile terminals that the user should take away from the vehicle.

FIG. 4 shows a flowchart of a method for updating the preset threshold automatically in the present embodiment.

As shown in FIG. 4, the method for updating the preset threshold automatically may include following steps S31 through S33.

S31, detecting the number of mobile terminals connected to the vehicle periodically by taking a predetermined first time period as a cycle.

S32, determining a minimal value of the number of the mobile terminals connected to the vehicle detected by taking a predetermined second time period as a cycle.

Specifically, the predetermined first time period is a detecting period, the predetermined second time period is a statistics period, the predetermined second time period includes at least one the predetermined first time period, that is, the duration of the predetermined second time period is equal to or greater than the duration of the predetermined first time period. For example, the predetermined first time period may be in a range from two minutes to five minutes, and the predetermined second time period may be in a range from three hours to eight hours.

S33, setting the minimal value of the number of the mobile terminals connected to the vehicle detected in the predetermined second time period as the preset threshold.

Specifically, the minimal value of the number of the mobile terminals connected to the vehicle detected in the predetermined second time period is equal to the number of the mobile terminals that are always placed in the vehicle and do not have to be taken away from the vehicle.

In a case where the user adds a new mobile terminal that will be always placed in the vehicle or the user will place a mobile terminal in the vehicle for a long time, by executing steps S31 through S33 described above, a change of the number of mobile terminals that are always placed in the vehicle and do not have to be taken away from the vehicle will be detected, and the preset threshold will be updated automatically so that the preset threshold is more accurate.

### Third Embodiment

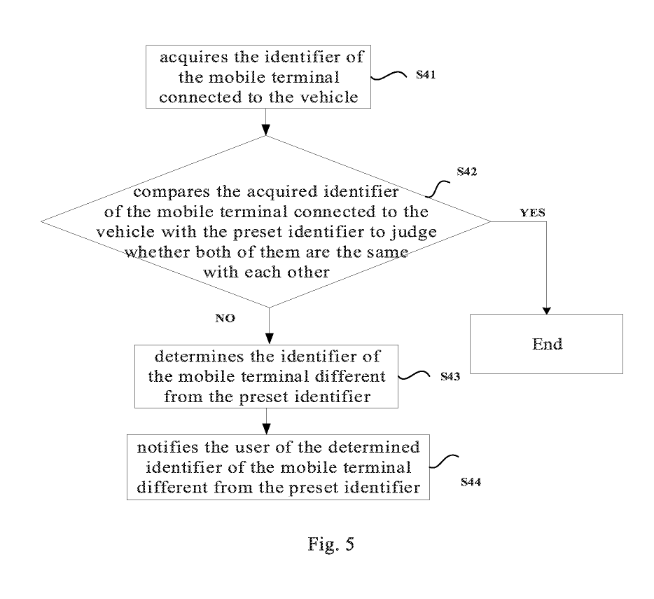

A procedure of a method for reminding a forgotten mobile terminal in according with the present embodiment is described in detail below in conjunction with FIG. 5.

In the present embodiment, the information of the mobile terminal detected by the vehicle controller is the identifier of the mobile terminal, and the preset information includes a preset identifier of the mobile terminal.

As shown in FIG. 5, the method of the present embodiment for reminding the forgotten mobile terminal includes following steps S41 through S44.

S41, the vehicle controller acquires the identifier of the mobile terminal connected to the vehicle.

Specifically, the vehicle controller may acquire, by various manners, identifiers of all mobile terminals connected to the vehicle in respective ways.

S42, the vehicle controller compares the acquired identifier of the mobile terminal connected to the vehicle with the preset identifier to judge whether both of them are the same with each other.

For example, the preset identifier may be an identifier of a mobile terminal that is always placed in the vehicle and does not have to be taken away from the vehicle. Specifically, the vehicle controller judges whether identifiers of mobile terminals currently connected to the vehicle are all the same as the preset identifier, in a case where the identifiers of the mobile terminals currently connected to the vehicle are all the same as the preset identifier, it indicates that there is no mobile terminal forgotten in the vehicle, the procedure is finished, and in a case where the identifiers of the mobile terminals currently connected to the vehicle are not all the same as the preset identifier, it indicates that there is at least one mobile terminal forgotten in the vehicle, the step S43 should be executed.

S43, the vehicle controller determines the identifier of the mobile terminal different from the preset identifier in accordance to the judgment result of step S42.

Specifically, in a case where the identifiers of the mobile terminals currently connected to the vehicle are not all the same as the preset identifier, the vehicle controller determines the identifier of the mobile terminal different from the preset identifier, which is regarded as the identifier of the mobile terminal that should be taken away from the vehicle but is forgotten in the vehicle.

S44, the vehicle controller notifies the user of the determined identifier of the mobile terminal different from the preset identifier.

For example, the vehicle controller may transmit the determined identifier of the mobile terminal different from the preset identifier to a preset mobile terminal that the user always carries.

With the steps S41 through S44, the solution of the present embodiment can notify the user of the identifier of the mobile terminal that is forgotten in the vehicle, so that the user can judge whether it is necessary to take the corresponding mobile terminal away from the vehicle.

It should be noted that, in a case where the step S41 is executed before the user leaves the vehicle and it is known that the user has carried a mobile terminal into the vehicle, the step S42 may be omitted, then in the step S43, the identifier of the mobile terminal different from the preset identifier is determined, and in the step S44, the user is reminded of the identifier of the mobile terminal that should be taken away from the vehicle.

### Fourth Embodiment

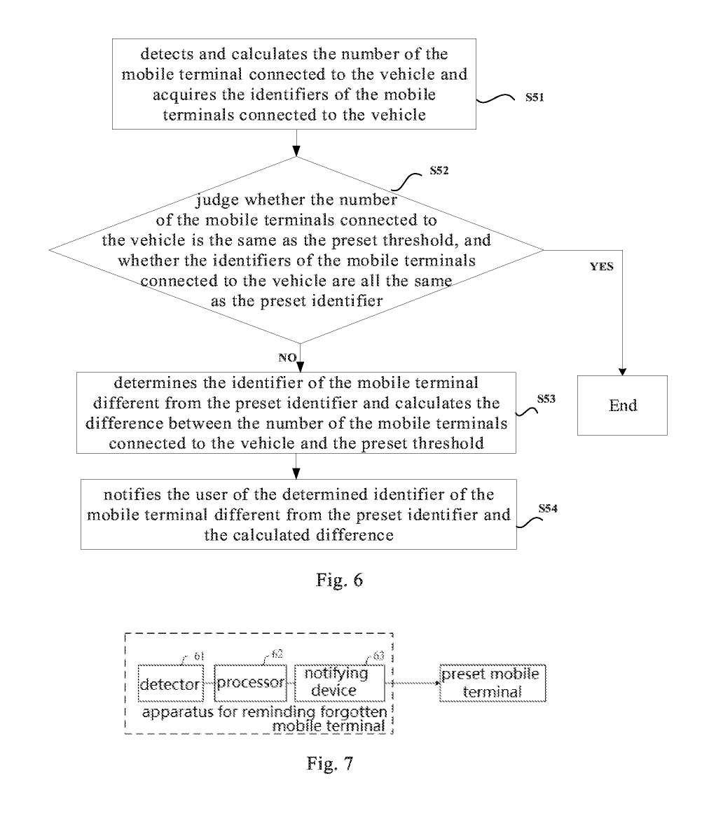

A procedure of a method for reminding a forgotten mobile terminal in accordance with the present embodiment is described in detail below in conjunction with FIG. 6.

In the present embodiment, the information of the mobile terminal detected by the vehicle controller includes the number of mobile terminals and identifiers of the mobile terminals, and the preset information includes a preset threshold and a preset identifier of a mobile terminal.

As shown in FIG. 6, the method of the present embodiment for reminding the forgotten mobile terminal includes following steps S51 through S54.

S51, the vehicle controller detects and calculates the number of the mobile terminal connected to the vehicle and acquires the identifiers of the mobile terminals connected to the vehicle.

S52, the vehicle controller respectively compares the number of the mobile terminals connected to the vehicle with the preset threshold and the identifiers of the mobile terminals connected to the vehicle with the preset identifier to judge whether the number of the mobile terminals connected to the vehicle is the same as the preset threshold, and whether the identifiers of the mobile terminals connected to the vehicle are all the same as the preset identifier.

Specifically, in a case where the number of the mobile terminals connected to the vehicle is the same as the preset threshold and the identifiers of the mobile terminals connected to the vehicle are all the same as the preset identifier, it indicates that there is no mobile terminal forgotten in the vehicle, and the mobile terminals currently connected to the vehicle are all mobile terminals that are always placed in the vehicle and do not have to be taken away from the vehicle, the procedure is finished, and in a case where the number of the mobile terminals connected to the vehicle is different from the preset threshold and the identifiers of the mobile terminals connected to the vehicle are not all the same as the preset identifier, it indicates that there is a mobile terminal forgotten in the vehicle, the step S53 should be executed.

S53, the vehicle controller determines the identifier of the mobile terminal different from the preset identifier and calculates the difference between the number of the mobile terminals connected to the vehicle and the preset threshold in accordance with the judgment result of S52.

Specifically, in a case where the identifiers of the mobile terminals currently connected to the vehicle are not all the same as the preset identifier and the number of the mobile terminals currently connected to the vehicle is different from the preset threshold, the identifier of the mobile terminal different from the preset identifier is determined and the difference between the number of the mobile terminals connected to the vehicle and the preset threshold.

It should be noted that, the preset threshold may be set manually or updated automatically, but the procedure for updating the preset threshold automatically will not be described in detail again here.

S54, the vehicle controller notifies the user of the determined identifier of the mobile terminal different from the preset identifier and the difference between the number of the mobile terminals connected to the vehicle and the preset threshold.

For example, the vehicle controller may simultaneously transmit the determined identifier of the mobile terminal different from the preset identifier and the difference between the number of the mobile terminals connected to the vehicle and the preset threshold to a preset mobile terminal that the user always carries.

With steps S51 through S54, the solution of the present embodiment not only can notify the user of the number of the mobile terminals forgotten in the vehicle, but also can notify the user of the identifier of the mobile terminal forgotten in the vehicle, and compared with the solution of the second embodiment which only reminds the user of the number of the mobile terminals forgotten in the vehicle and the solution of the third embodiment which only reminds the user of the identifier of the mobile terminal forgotten in the vehicle, the present embodiment can achieve a better effect.

It should be noted that, in a case where the step S51 is executed before the user leaves the vehicle and it is known that the user has carried a mobile terminal into the vehicle, the step S52 may be omitted, then in the step S53, the identifier of the mobile terminal different from the preset identifier is determined and the difference between the number of the mobile terminals connected to the vehicle and the preset threshold is calculated, and in the step S54, the user is reminded of the number and the identifiers of the mobile terminals that should be taken away from the vehicle.

The steps of the embodiments are not all necessary, and some steps may be omitted or changed in accordance with the practical application scene, moreover, the steps may be arbitrarily combined, for example, under the uncertainty of whether the user has carried a mobile terminal to get in the vehicle, the number of the mobile terminals connected to the vehicle may be detected and calculated first, and is compared with the preset threshold so as to judge whether both of them are the same with each other, in a case where the number of the mobile terminals connected to the vehicle is the same as the preset threshold, it indicates that there is a mobile terminal that should be taken away, and in this case, the difference between the number of the mobile terminals connected to the vehicle and the preset threshold is calculated, and meanwhile, the identifiers of the mobile terminals connected to the vehicle may also be acquired, and the acquired identifiers of the mobile terminals connected to the vehicle are compared with the preset identifier so as to determine the identifier of the mobile terminal different from the preset identifier, and then, the calculated difference between the number of the mobile terminals connected to the vehicle and the preset threshold and the determined identifier of the mobile terminal different from the preset identifier are notified to the user. Moreover, even if no mobile terminal that is forgotten and should be taken away is detected, the user may also be notified that there is no mobile terminal that is forgotten and should be taken away.

Furthermore, the method for reminding the forgotten mobile terminal in accordance with embodiments described above may further include steps: the vehicle controller receives the position information reported by the mobile terminal connected to the vehicle. In this case, in a case where the vehicle controller judges that the information of the mobile terminal currently connected to the vehicle is different from the preset information, the vehicle controller may further notify the user of the position information reported by the mobile terminal, that is, notify the user of the position of the mobile terminal forgotten in the vehicle, so that the user can find the mobile terminal easily.

It should be noted that, the above embodiments are described by taking the vehicle controller executing the steps as example, however, the present disclosure is not limited thereto, and the steps may also be executed by other devices or apparatuses. In addition, the solutions of the present disclosure may also be applied to other application scenes, for example, to a scene in which the user should take the mobile terminal away from home or company, and in this case, for example, a smart home controller may be used for detecting the information of the mobile terminal connected to a device in the home, or a smart device placed in the company may be used for detecting the information of the mobile terminal connected to a device in the company.

Based on a same conception, an embodiment of the present disclosure further provides an apparatus for reminding a forgotten mobile terminal, and as shown in FIG. 7, the apparatus for reminding the forgotten mobile terminal includes a detector 61, a processor 62 and a notifying device 63.

The detector 61 is configured to detect the information of the mobile terminal connected to the predetermined device. Specifically, the information of the mobile terminal to be detected may include the number of mobile terminals and/or the identifiers of the mobile terminals, and the predetermined device may be a device fixed in a place that the user is leaving.

The processor 62 is configured to compare the detected information of the mobile terminal connected to the predetermined device with the preset information to judge whether both of them are the same with each other, and in a case where the detected information of the mobile terminal connected to the predetermined device is different from the preset information, to instruct the notifying device 63 to notify the user.

It should be noted that, in a case where the detected information of the mobile terminal is the number of mobile terminals and the preset information includes the preset threshold, the processor 62 is configured to compare the detected number of the mobile terminals connected to the predetermined device with the preset threshold, and in a case where the number of the mobile terminals connected to the predetermined device is different from the preset threshold (e.g., the number of the mobile terminals connected to the predetermined device is greater than the preset threshold), to calculate the difference between the number of the mobile terminals connected to the predetermined device and the preset threshold, and instruct the notifying device 63 to notify the user. For example, the processor 62 may be configured to instruct the notifying device 63 to transmit the difference to a preset mobile terminal that the user always carries.

It should be noted that, in a case where the information of the mobile terminal to be detected includes the identifier of the mobile terminal and the preset information includes the preset identifier, the processor 62 is configured to compare the identifier of the mobile terminal connected to the predetermined device with the preset identifier, and in a case where the identifier of the mobile terminal connected to the predetermined device is different from the preset identifier, the identifier of the mobile terminal different from the preset identifier is determined, and to instruct the notifying device 63 to notify the user of the determined identifier of the mobile terminal different from the preset identifier.

It should be noted that, in a case where the information of the mobile terminal to be detected includes the number of mobile terminals and the identifiers of the mobile terminals, and the preset information includes the preset threshold and the preset identifier, the processor 62 is configured to respectively compare the number of the mobile terminals connected to the predetermined device with the preset threshold, and the identifiers of the mobile terminals connected to the predetermined device with the preset identifier to judge whether the number of the mobile terminals currently connected to the predetermined device and the preset threshold are the same with each other and whether the identifiers of the mobile terminals connected to the predetermined device are all the same as the preset identifier, and in a case where the number of the mobile terminals connected to the predetermined device is different from the preset threshold and the identifiers of the mobile terminals connected to the predetermined device are not all the same as the preset identifier, to calculate the difference between the number of the mobile terminals connected to the predetermined device and the preset threshold and determines the identifier of the mobile terminal different from the preset identifier, and instruct the notifying device 63 to notify the user of the difference and the determined identifier of the mobile terminal different from the preset identifier.

In the present embodiment, the detector 61 may be configured to detect the number of mobile terminals connected to the predetermined device periodically in by taking a predetermined first time period as a cycle, determine a minimal value of the number of the mobile terminals connected to the predetermined device in by taking a predetermined second time period as a cycle, and set the minimal value as the preset threshold is equal to the minimal value, wherein the predetermined second time period comprises at least one the predetermined first time period.

In the present embodiment, the trigger condition for triggering the detector 61 to detect the information of the mobile terminal connected to the predetermined device may be adjusted and set in accordance with practical application scenes, and the predetermined device may also be determined in accordance with the practical application scenes, mobile terminals may be connected with the predetermined device in various ways.

Furthermore, in the present embodiment, the apparatus for reminding the forgotten mobile terminal may be included in various facilities in accordance with practical application scenes, for example, the apparatus for reminding the forgotten mobile terminal may be implemented to be included in a wearable device, and in this case, for example, the notifying device 63 may directly notify the user and does not need to transmit the notification information to any other device.

In the present embodiment, the detector 61, the processor 62 and the notifying device 63 may be implemented by hardware (e.g., including a processor) and/or computer program, which is not limited by the present disclosure, as long as corresponding functions can be achieved.

Technical means and features of embodiments of the present disclosure are not all necessary, and some of them may be omitted in accordance with practical application scenes, and moreover, the technical means and features may be combined arbitrarily, the method for reminding the forgotten mobile terminal in accordance with embodiments of the present disclosure and various modifications and variants thereof may be implemented by the apparatus for reminding the forgotten mobile terminal in accordance with embodiments of the present disclosure, for example, the vehicle controller employed in the method for reminding the forgotten mobile terminal in accordance with embodiments of the present disclosure may be included in the apparatus for reminding the forgotten mobile terminal in accordance with embodiments of the present disclosure.

It should be understood that, the above embodiments are merely exemplary embodiments for explaining principle of the present invention, but the present invention is not limited thereto. Various modifications and improvements may be made by those ordinary skilled in the art within the spirit and essence of the present invention, these modifications and improvements fall into the protection scope of the present invention.

1. A method for reminding a forgotten mobile terminal, comprising steps:
S1, detecting information of a mobile terminal connected to a predetermined device;
S2, comparing detected information of the mobile terminal connected to the predetermined device with preset information to judge whether both of them are the same with each other;
S3, notifying a user whether there is a mobile terminal should be taken away in accordance with a judgment result of S2.

2. The method of claim 1, wherein the information of the mobile terminal to be detected comprises the number of mobile terminals, and the preset information comprises a preset threshold,
in a case where a detected number of the mobile terminals connected to the predetermined device is different from the preset threshold,
the step S2 further comprises calculating a difference between the number of the mobile terminals connected to the predetermined device and the preset threshold, and
the step S3 further comprises notifying the user of the difference.

3. The method of claim 2, wherein the step S3 comprises: transmitting the difference to a predetermined terminal to notify the user via the predetermined terminal.

4. The method of claim 1, wherein the information of the mobile terminal to be detected comprises an identifier of the mobile terminal, and the preset information comprises a preset identifier of a mobile terminal,
in a case where the detected identifier of the mobile terminal connected to the predetermined device is different from the preset identifier,
the step S2 further comprises determining the identifier of the mobile terminal different from the preset identifier, and
the step S3 further comprises notifying the user of the determined identifier of the mobile terminal different from the preset identifier.

5. The method of claim 1, wherein the information of the mobile terminal to be detected comprises the number of mobile terminals and identifiers of the mobile terminals, the preset information comprises a preset threshold and a preset identifier of a mobile terminal,
in a case where the detected number of the mobile terminals connected to the predetermined device is different from the preset threshold and the detected identifiers of the mobile terminals are not all the same as the preset identifier,
the step S2 further comprises calculating a difference between the number of the mobile terminals connected to the predetermined device and the preset threshold and determining an identifier of a mobile terminal among the mobile terminals different from the preset identifier, and
the step S3 further comprises notifying the user of the calculated difference and the determined identifier of the mobile terminal different from the preset identifier.

6. The method of claim 2, further comprising steps of:
detecting the number of mobile terminals connected to the predetermined device periodically by taking a predetermined first time period as a cycle;
determining a minimal value of the number of the mobile terminals connected to the predetermined device by taking a predetermined second time period as a cycle, and setting the minimal value as the preset threshold, the predetermined second time period comprises at least one the predetermined first time period.

7. The method of claim 5, further comprising steps of:
detecting the number of mobile terminals connected to the predetermined device periodically by taking a predetermined first time period as a cycle;
determining a minimal value of the number of the mobile terminals connected to the predetermined device by taking a predetermined second time period as a cycle, and setting the minimal value as the preset threshold, the predetermined second time period comprises at least one the predetermined first time period.

8. The method of claim 1, wherein the predetermined device is a device fixed in a place where the user is leaving, and a trigger condition which triggers the step S1 to be executed is an event which indicates that the user is leaving the place.

9. The method of claim 2, wherein the step S1 comprises: detecting the information of mobile terminals connected to the predetermined device in respective ways, and calculating the total number of the mobile terminals connected to the predetermined devices in respective ways.

10. The method of claim 4, wherein the step S1 comprises: detecting identifiers of all mobile terminals connected to the predetermined device in respective ways.

11. An apparatus for reminding a forgotten mobile terminal, comprising a processor configured to detect information of a mobile terminal connected to a predetermined device, compare the detected information of the mobile terminal connected to the predetermined device with preset information to judge whether both of them are the same with each other, and notify a user whether there is a mobile terminal should be taken away in accordance with a judgment result.

12. The apparatus of claim 11, wherein the information of the mobile terminal to be detected comprises the number of mobile terminals, and the preset information comprises a preset threshold,
the processor is configured to, in a case where the detected number of the mobile terminals connected to the predetermined device is different from the preset threshold, calculate a difference between the number of the mobile terminals connected to the predetermined device and the preset threshold, and notify the user of the difference.

13. The apparatus of claim 12, wherein the processor is configured to transmit the difference to a predetermined terminal to notify the user via the predetermined terminal.

14. The apparatus of claim 11, wherein the information of the mobile terminal to be detected comprises an identifier of the mobile terminal, and the preset information comprises a preset identifier of a mobile terminal,
the processor is configured to, in a case where the detected identifier of the mobile terminal connected to the predetermined device is different from the preset identifier, determine the identifier of the mobile terminal different from the preset identifier, and notify the user of the determined identifier of the mobile terminal different from the preset identifier.

15. The apparatus of claim 11, wherein the information of the mobile terminal to be detected comprises the number of mobile terminals and identifiers of the mobile terminals, the preset information comprises a preset threshold and a preset identifier,
the processor is configured to, in a case where the detected number of the mobile terminals connected to the predetermined device is different from the preset threshold and the detected identifiers of the mobile terminals are not all the same as the preset identifier, calculate a difference between the number of the mobile terminals connected to the predetermined device and the preset threshold and determining an identifier of a mobile terminal among the mobile terminals different from the preset identifier, and notify the user of the calculated difference and the determined identifier of the mobile terminal different from the preset identifier.

16. The apparatus of claim 12, wherein the processor may further be configured to detect the number of mobile terminals connected to the predetermined device periodically by taking a predetermined first time period as a cycle, determine a minimal value of the number of the mobile terminals connected to the predetermined device by taking a predetermined second time period as a cycle, and set the minimal value as the preset threshold, wherein the predetermined second time period comprises at least one the predetermined first time period.

17. The apparatus of claim 11, wherein the predetermined device is a device fixed in a place where the user is leaving, and a trigger condition which triggers the processor to start to detect the information of the mobile terminal connected to the predetermined device is an event which indicates that the user is leaving the place.

18. The apparatus of claim 12, wherein the processor is configured to detect the information of mobile terminals connected to the predetermined device in respective ways, and calculate a total number of the mobile terminals connected to the predetermined devices in respective ways.

19. The apparatus of claim 14, wherein the processor is configured to detect identifiers of all mobile terminals connected to the predetermined device in respective ways.

20. A recording medium recorded with a computer program for executing the method for reminding a forgotten mobile terminal of claim 1.
